(19) United States
(12) Patent Application Publication
(10) Pub. No.: US 2017/0125962 A1
(43) Pub. Date: May 4, 2017

(54) ASSEMBLING METHOD AND STRUCTURE THEREOF

(71) Applicant: YAZAKI CORPORATION, Tokyo (JP)

(72) Inventor: Tetsuya SEKINO, Shizuoka (JP)

(73) Assignee: YAZAKI CORPORATION, Tokyo (JP)

(21) Appl. No.: 15/362,854

(22) Filed: Nov. 29, 2016

Related U.S. Application Data
(63) Continuation of application No. PCT/JP2015/065226, filed on May 27, 2015.

(30) Foreign Application Priority Data
May 30, 2014 (JP) 2014-111963

(51) Int. Cl. H01R 43/04; H01R 13/502

(52) U.S. Cl. CPC H01R 43/04; H01R 13/502

(57) ABSTRACT

An assembling method of assembling a male housing 2 and first and second members 4 and 6 through a cap 3. The method includes a process of placing the cap 3 on the male housing 2, a process of assembling the housing 2 and the first and second members 4 and 6 into one, a process of moving the cap 3 toward the second member 6, and a process of swaging the cap 3.

### CROSS REFERENCE TO RELATED APPLICATION

This application is a Continuation of PCT Application No. PCT/JP2015/065226 filed on May 27, 2015 and claims the benefit of priority under 35 U.S.C. 119(a) to Japanese Patent Application No. 2014-111963 filed on May 30, 2014 whose disclosed contents are incorporated herein by reference.

### BACKGROUND

Technical Field

The present invention relates to an assembling method and its structure, and particularly, to an assembling method used when connecting parts to each other and its structure.

Background Art

Connecting a male housing and a cap to each other has been made so far by fitting the cap to the male housing from a fitting face side of the male housing. This cap is an object to protect a connection part of the male housing.

Namely, there are carried out (1) fitting parts to the male housing, (2) processing, for example, fixing the fitted parts, (3) mating the cap with the male housing, and (4) fastening the cap to the male housing and parts. These processes (1) to (4) have conventionally been conducted. Patent literatures for related connectors include, for example, United States Patent Application Publication No. 2010/003841A1 (Patent Literature 1).

### SUMMARY OF INVENTION

### Problems to be Solved by Invention

According to the related art, there is a problem that, when mating the cap with the male housing, the cap is unable to be placed thereon if an inner diameter of the cap is smaller than an outer diameter of the male housing.

Namely, if outer part of the male connector involves stopper projections or ribs, the outer diameter of the male housing exceeds the inner diameter of the cap so that they become unable to be fitted to each other.

Enlarging the cap (enlarging the inner diameter thereof), however, will increase play when the cap covers the connection part. If caulking is carried out under this state, the increased play will have the caulked state unevenly shaped.

Means to Solve Problems

To solve the above-mentioned problems, a technical aspect of the present invention provides an assembling method of assembling first and second members and a male housing into one. The method is characterized in that it includes a process of placing a cap on the male housing from a rear side thereof, a process of assembling the first and second members and the male housing into one, a process of moving the cap toward the second member, and a process of swaging the cap.

Another technical aspect of the present invention provides an assembling structure of a male housing and first and second members. The structure is characterized in that it is constituted by placing a cap having an inner diameter smaller than an outer diameter of the male housing on the male housing, assembling the first and second members and the male housing with the cap into one, and swaging the cap moved toward the second member.

### BRIEF DESCRIPTION OF DRAWINGS

FIGS. 1A and 1B are explanatory views explaining an assembled structure.

FIG. 2 is an enlarged view illustrating a connection part.

FIGS. 3A and 3B are explanatory views explaining the placement of a cap on a male housing.

FIGS. 4A and 4B are explanatory views explaining the placement of the cap onto the male housing.

FIGS. 5A and 5B are explanatory views explaining connection between the male housing and a first member.

FIGS. 6A and 6B are explanatory views explaining connection between the male housing and the first member.

FIG. 7 is an explanatory view explaining the setting of a substrate.

FIGS. 8A and 8B are explanatory views explaining the setting of the substrate.

FIGS. 9A and 9B are explanatory views explaining the placement of a second member.

FIGS. 10A and 10B are explanatory views explaining the placement of the second member.

FIGS. 11A, 11B, and 11C are explanatory views explaining the moving and swaging of the cap.

### MODE OF IMPLEMENTING INVENTION

An embodiment of the present invention will be explained hereunder with reference to the drawings.

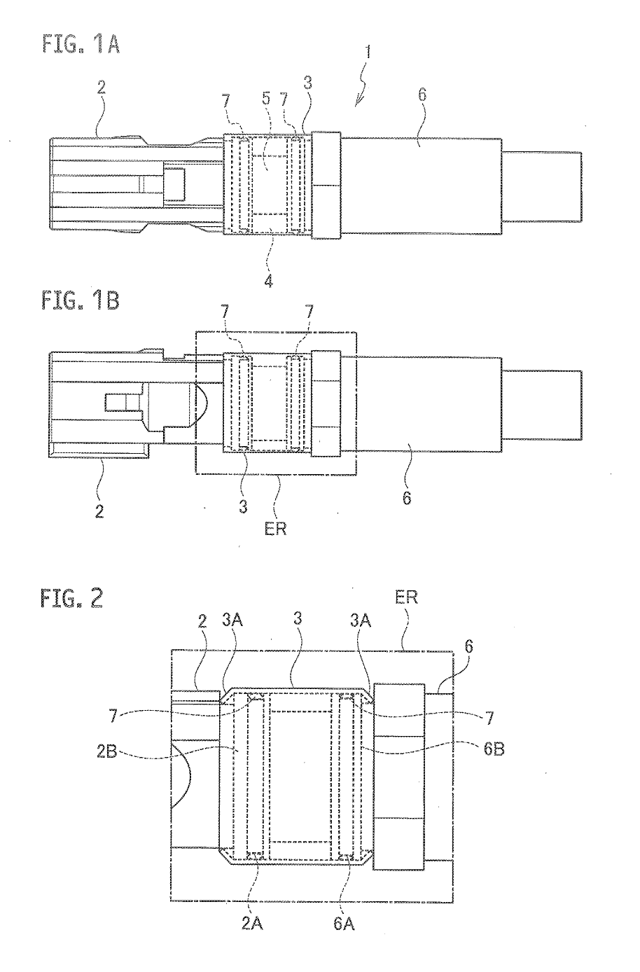

FIGS. 1A, 1B, and 2 are referred to. FIG. 1A is a front view illustrating an assembled structure 1. FIG. 1B is a side view illustrating the assembled structure 1. FIG. 2 is an enlarged view illustrating a connection part ER.

A male housing 2, a member (a first member) 4, and another member (a second member) 6 are assembled through a cap 3 into the assembled structure 1. Namely, the cap 3 is placed on the male housing 2 from a rear side thereof, the member 4 is mated with the male housing 2, the cap 3 is moved toward the member 4, and the cap 3 is swaged to form the assembled structure 1.

With this, even if a front diameter of the male housing 2 is larger than an inner diameter of the cap 3, the cap 3 can beforehand be placed on the male housing 2 from the rear side thereof.

A method of assembling the male housing 2 and the first and second members 4 and 6 into a unit through the cap 3 will be explained.

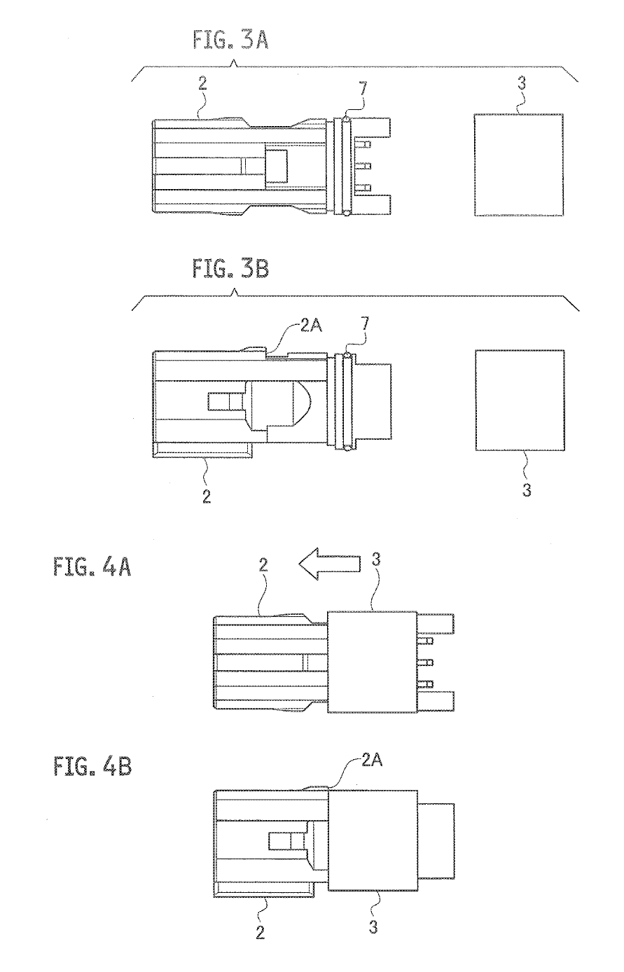

FIG. 3A is a plan view of the male housing 2 and cap 3 and FIG. 3B is a side view of the male housing 2 and cap 3. Here, the male housing 2 and cap 3 are prepared.

FIG. 4A is a plan view when the cap 3 is placed on the male housing 2 from behind and FIG. 4B is a side view when the cap 3 is placed on the male housing 2 from behind. First, the cap 3 is placed on the male housing 2. Namely, an end face of the cap 3 is inserted until it comes into contact with a projection end face 2A of the male housing 2.

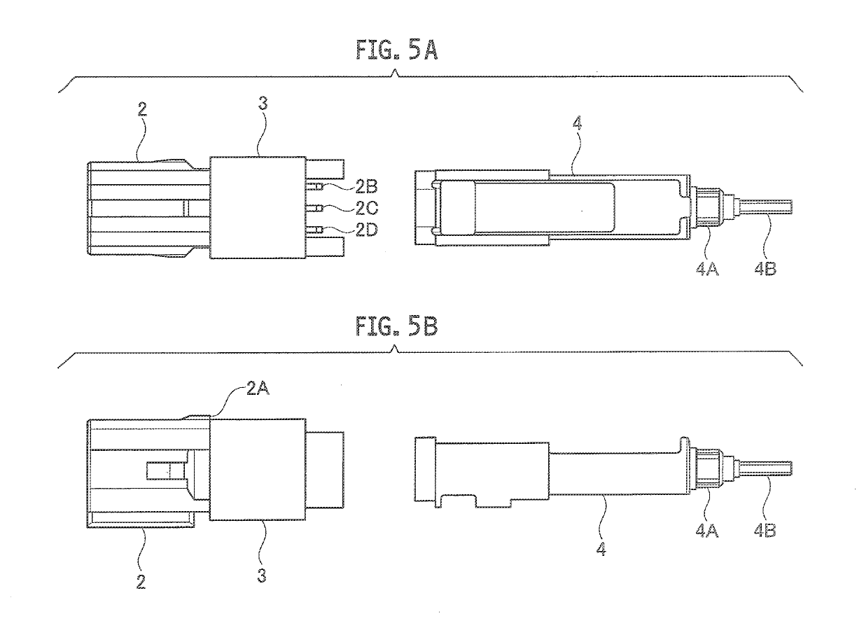

FIG. 5A is a plan view of the male housing 2 and member 4 with the inserted cap 3 and FIG. 5B is a side view of the male housing 2 and member 4 with the inserted cap 3.

Here, the member 4 to be inserted into the male housing 2 is prepared. The male housing 2 has terminals 2B, 2C, and 2D that are connected to a substrate 5. The first member 4 has a thread (a screw portion) 4A for mating with the second member 6 and a sensor 4B.

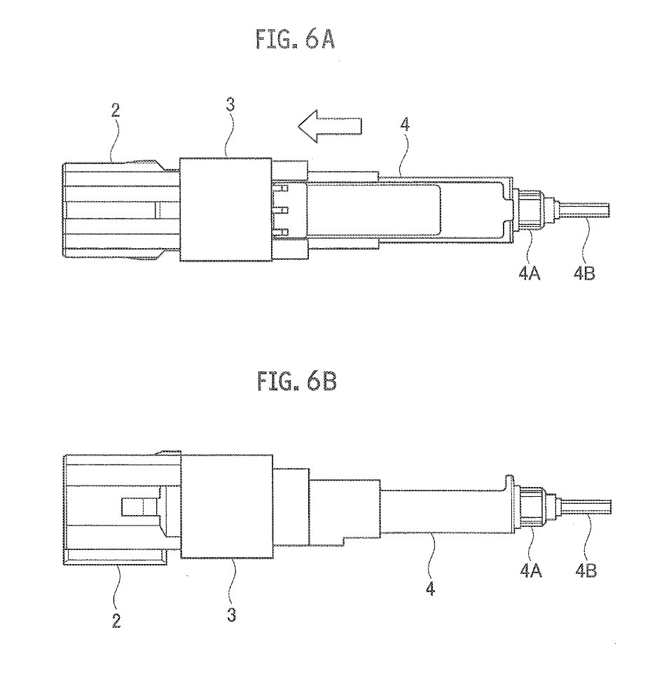

FIG. 6A is a plan view when the member 4 is inserted into the male housing 2 and FIG. 6B is a side view when the member 4 is inserted into the male housing 2. The member 4 is mated with the male housing 2.

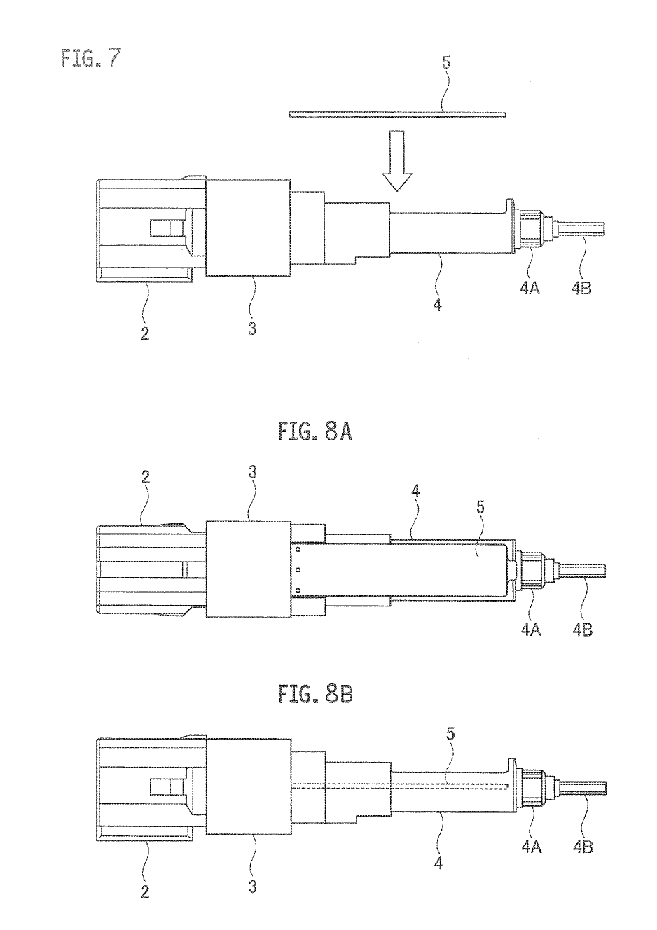

Referring to FIG. 7, the substrate 5 to be set on the member 4 is prepared.

FIG. 8A is a plan view when the substrate 5 is attached to the member 4 and FIG. 8B is a side view when the substrate 5 is attached to the member 4. The substrate 5 is attached through the terminals 2B, 2C, and 2D to the member 4.

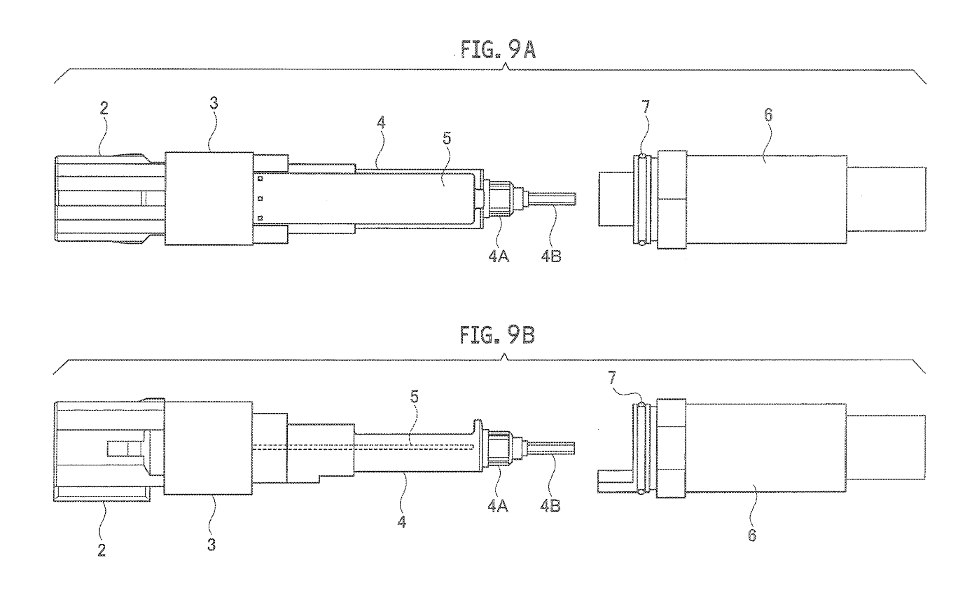

FIG. 9A is a plan view when the second member stands by the first member and FIG. 9B is a side view when the second member stands by the first member. Here, the second member 6 is prepared to be fitted to the first member 4.

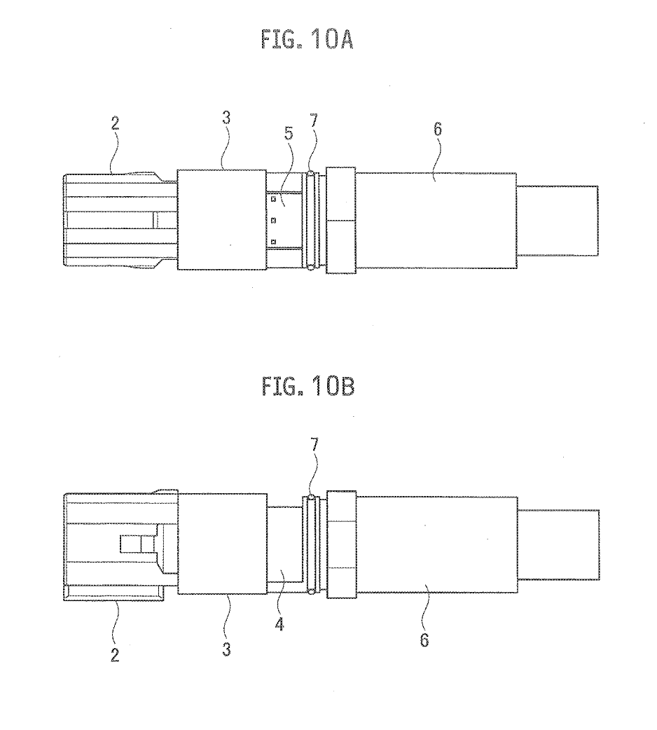

FIG. 10A is a plan view when the second member is fitted and FIG. 10B is a side view when the second member is fitted. Here, the second member 6 is fitted to the first member 4. At this time, the thread 4A is used for the fixation of the second member 6 and the first member 4.

Before moving the cap 3 toward the member 4, the substrate 5 is adjusted.

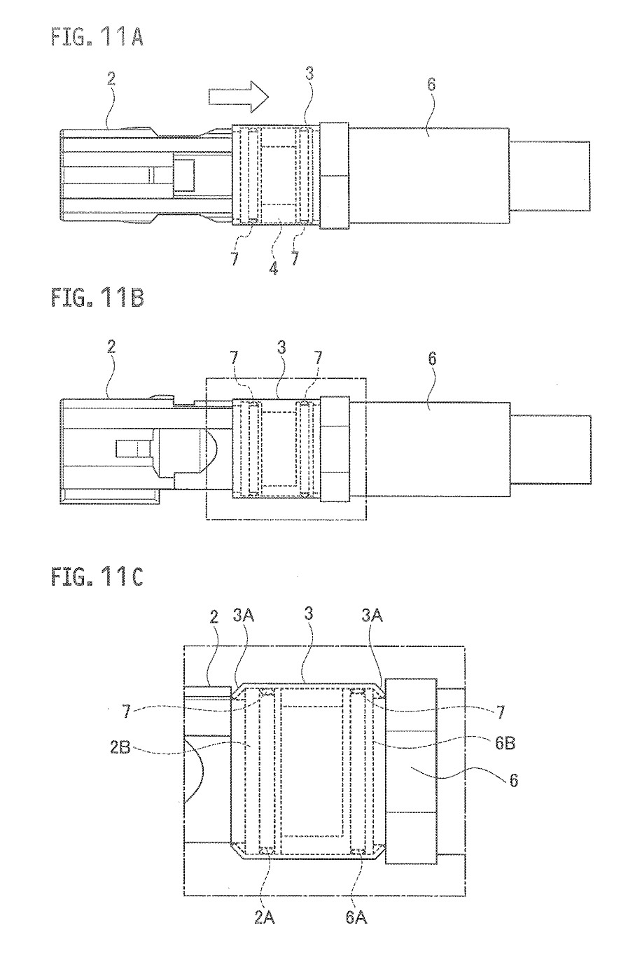

FIG. 11A is a plan view when the cap 3 is moved toward the second member 6, FIG. 11B is a side view when the cap 3 is moved toward the second member 6, and FIG. 11C is an enlarged view of the connection part when the cap 3 is moved toward the second member 6. The cap 3 is moved toward the second member 6 and is swaged.

An O-ring groove 2A is formed on the male housing and an O-ring groove 6A is formed on the second member 6.

The O-ring grooves 2A and 6A receive O-rings 7, respectively. The O-ring grooves 2A and 6A are formed with circumferential ribs 2B and 6B, respectively. With edges of the ribs 2B and 6B, there are engaged inner edges of tapers 3A that are formed when the cap 3 is swaged. This prevents the cap 3 from becoming unsteady.

In this way, the male housing 2 and member 4 are assembled with the cap 3 into the assembled structure 1. In the structure, the cap 3 is placed on the male housing 2, the member 4 is mated with the male housing 2, the cap 3 is moved toward the member 4, and the cap 3 is swaged for fastening to complete the assembled structure 1.

This invention is not limited to the above-mentioned embodiment, but with proper modifications, the invention is achievable in other forms.

According to the present invention, even a male housing whose periphery is provided with projections such as ribs and stopper projections is able to beforehand receive a cap from a rear side of the male housing. Thereafter, a part is connected to the male housing, a substrate is adjusted, and the connected part is covered with the cap.

1. An assembling method of assembling first and second members and a male housing, the method comprising:
a process of placing a cap on the male housing from a rear side thereof;
a process of assembling the first member and the second member and the male housing;
a process of moving the cap toward the second member; and
a process of swaging the cap.

2. The assembling method according to claim 1, further comprising
the method further comprises a process of attaching a substrate to the first member, wherein the substrate is adjusted before the cap is moved toward the second member.

3. The assembling method according to claim 1, wherein the male housing has an O-ring groove and the second member has an O-ring groove.
